(19) United States
(12) Patent Application Publication
(10) Pub. No.: US 2022/0398699 A1
(43) Pub. Date: Dec. 15, 2022

(54) IMAGE PROCESSING METHOD AND APPARATUS FOR MACHINE VISION

(71) Applicant: Electronics and Telecommunications Research Institute, Daejeon (KR)

(72) Inventors: Hyon-Gon CHOO, Daejeon (KR); Jeong-Il SEO, Daejeon (KR); Jin-Young LEE, Daejeon (KR); Hee-Kyung LEE, Daejeon (KR); Han-Shin LIM, Daejeon (KR); Won-Sik CHEONG, Daejeon (KR)

(73) Assignee: Electronics and Telecommunications Research Institute, Daejeon (KR)

(21) Appl. No.: 17/839,181

(22) Filed: Jun. 13, 2022

(30) Foreign Application Priority Data
Jun. 14, 2021 (KR) 10-2021-0076884
May 17, 2022 (KR) 10-2022-0060347

(51) Int. Cl. G06T 5/00

(52) U.S. Cl. CPC G06T 5/006; G06T 2207/20084

(57) ABSTRACT

Disclosed herein are an image processing method and apparatus for machine vision. The image processing method for machine vision includes generating an image with machine-unrecognizable distortion based on an input image, and encoding the image with machine-unrecognizable distortion.

### CROSS REFERENCE TO RELATED APPLICATIONS

This application claims the benefit of Korean Patent Application Nos. 10-2021-0076884, filed Jun. 14, 2021, and 10-2022-0060347, filed May 17, 2022, which are hereby incorporated by reference in their entireties into this application.

### BACKGROUND OF THE INVENTION

### 1. Technical Field

The present invention relates generally to technology for processing images (or video) based on the characteristics of machine vision tasks.

More particularly, the present invention relates to technology for providing high compressibility while maintaining excellent performance by using image with machine-unrecognizable distortion.

### 2. Description of the Related Art

Recently, as machine learning-based technology using deep learning surpasses the performance of existing technology in various fields and secures the performance enabling commercialization, it may be settled as core technology in each industrial field.

In particular, success in technology in machine vision fields, such as image recognition and image segmentation performed by inputting an image, enables the machine vision technology to be merged with existing industrial fields, and thus the range of application of the technology has been expanded to new areas such smart city, autonomous driving, smart factory, and smart content.

By means of this, the use of images (video) to be used for machines (machine vision) has gradually increased. The principal purpose of existing image compression technology is intended to improve compressibility while maintaining the best image quality suitable for human viewing.

However, in the future, there will be more cases in which the principal purpose to obtain visible/invisible light image data is machine-learning work, such as image recognition and segmentation, and higher-level machine-learning work based thereon in various industrial fields.

In this case, in order to further improve usefulness of image compression technology, the method for improving compressibility while maximally maintaining accuracy upon applying the target of image compression to machine learning work may be used.

Therefore, in consideration of the characteristics of machine vision, there is urgently required image processing technology for improving compressibility while maintaining the performance of machine vision.

### PRIOR ART DOCUMENTS

### Patent Documents

(Patent Document 1) Korean Patent Application Publication No. 10-2018-0002989 (Title: Image Processing Apparatus and Image Processing Method)
(Patent Document 2) Korean Patent Application Publication No. 10-2018-0014676 (Title: System and Method for Automatic Selection of 3D Alignment Algorithms in Vision System)
(Patent Document 3) Korean Patent Application Publication No. 10-2009-0096684 (Title: Method, Apparatus, and Computer-Readable Medium for Processing Night Vision Image Dataset)

### SUMMARY OF THE INVENTION

Accordingly, the present invention has been made keeping in mind the above problems occurring in the prior art, and an object of the present invention is to generate an image (or a video) having high compressibility while maintaining the performance of machine vision tasks in consideration of the characteristics of the machine vision tasks.

Another object of the present invention is to provide an image processing method that is capable of adjusting the extent of distortion depending on the characteristics of machine vision tasks or as occasion demands.

In accordance with an aspect of the present invention to accomplish the above objects, there is provided an image processing method for machine vision, including generating an image with machine-unrecognizable distortion image with machine-unrecognizable distortion based on an input image, and encoding the image with machine-unrecognizable distortion.

Generating the image with machine-unrecognizable distortion may include generating the image with machine-unrecognizable distortion using a deep learning network.

The deep learning network may be trained based on a first loss function corresponding to a generation error between the input image and the image with machine-unrecognizable distortion, a second loss function corresponding to a difference in performance between results obtained by individually performing a machine vision task on the input image and the image with machine-unrecognizable distortion, and a third loss function corresponding to a difference between coding bit amounts of the input image and the image with machine-unrecognizable distortion.

The image with machine-unrecognizable distortion may be generated by adding distortion corresponding to a characteristic of a machine vision task to the input image.

The distortion corresponding to the characteristic of the machine vision task may include de-texturization, edge detection, or de-colorization.

The image with machine-unrecognizable distortion may be an image to which multiple distortion components are added.

The image processing method may further include transmitting information about distortion added to an encoded image and the image with machine-unrecognizable distortion.

The image processing method may further include decoding the encoded image, and reducing strength of the distortion based on the information about the distortion and a characteristic of a machine vision task.

In accordance with another aspect of the present invention to accomplish the above objects, there is provided an image processing apparatus (encoding apparatus) for machine vision, including an image-processing unit for generating an image with machine-unrecognizable distortion based on an input image, and an encoding unit for encoding the image with machine-unrecognizable distortion.

The image-processing unit may generate the image with machine-unrecognizable distortion using a deep learning network.

The deep learning network may be trained based on a first loss function corresponding to a generation error between the input image and the image with machine-unrecognizable distortion, a second loss function corresponding to a difference in performance between results obtained by individually performing a machine vision task on the input image and the image with machine-unrecognizable distortion, and a third loss function corresponding to a difference between coding bit amounts of the input image and the image with machine-unrecognizable distortion.

The image with machine-unrecognizable distortion may be generated by adding distortion corresponding to a characteristic of the machine vision task to the input image.

The distortion corresponding to the characteristic of the machine vision task may include de-texturization, edge detection, or de-colorization.

The image with machine-unrecognizable distortion may be an image to which multiple distortion components are added.

The image processing apparatus (encoding apparatus) may further include a transmission unit for transmitting information about distortion added to an encoded image and the image with machine-unrecognizable distortion.

In accordance with a further aspect of the present invention to accomplish the above objects, there is provided an image processing apparatus (decoding apparatus) for machine vision, including a reception unit for receiving an encoded image with machine-unrecognizable distortion, a decoding unit for decoding the received image with machine-unrecognizable distortion, and a distortion reducing unit for reducing strength of distortion of the decoded image with machine-unrecognizable distortion.

The reception unit may receive information about distortion added to the image with machine-unrecognizable distortion, along with the image with machine-unrecognizable distortion.

The distortion added to the image with machine-unrecognizable distortion may include de-texturization, edge detection, or de-colorization.

The distortion reduction unit may reduce the strength of the distortion based on the information about the distortion and a characteristic of a machine vision task.

The image with machine-unrecognizable distortion may be an image to which multiple distortion components are added.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an example of a video coding method:

FIG. 2 is a diagram conceptually illustrating autoencoder-based compression technology, which is one of deep learning-based image compression technologies:

FIG. 3 is a diagram illustrating examples of the type of machine-unrecognizable distortion;

FIG. 4 is a flowchart illustrating an image processing method for machine vision according to an embodiment of the present invention:

FIG. 5 is a flowchart illustrating an image processing method for machine vision according to another embodiment of the present invention;

FIG. 6 is a diagram illustrating a machine vision processing system using an encoder and a decoder:

FIG. 7 is a block diagram illustrating a system for processing machine vision according to an embodiment of the present invention:

FIG. 8 is a block diagram illustrating a system for processing machine vision according to another embodiment of the present invention:

FIG. 9 is a diagram illustrating an example of a structure for training a network that generates machine-unrecognizable distortion:

FIG. 10 is a diagram illustrating the result of performing object detection on an original input image;

FIG. 11 is a diagram illustrating the result of performing object detection on a de-texturized image:

FIG. 12 is a block diagram illustrating an image processing apparatus (a transmitter) according to an embodiment of the present invention;

FIG. 13 is a block diagram illustrating an image processing apparatus (a receiver) according to an embodiment of the present invention; and

FIG. 14 is a diagram illustrating the configuration of a computer system according to an embodiment.

### DESCRIPTION OF THE PREFERRED EMBODIMENTS

Advantages and features of the present invention and methods for achieving the same will be clarified with reference to embodiments described later in detail together with the accompanying drawings. However, the present invention is capable of being implemented in various forms, and is not limited to the embodiments described later, and these embodiments are provided so that this invention will be thorough and complete and will fully convey the scope of the present invention to those skilled in the art. The present invention should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present invention.

The terms used in the present specification are merely used to describe embodiments, and are not intended to limit the present invention. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present invention pertains. Further, terms defined in generally used dictionaries are not to be interpreted as having ideal or excessively formal meanings unless they are definitely defined in the present specification.

Hereinafter, embodiments of the present invention will be described in detail with reference to the accompanying drawings. In the following description of the present invention, the same reference numerals are used to designate the same or similar elements throughout the drawings and repeated descriptions of the same components will be omitted.

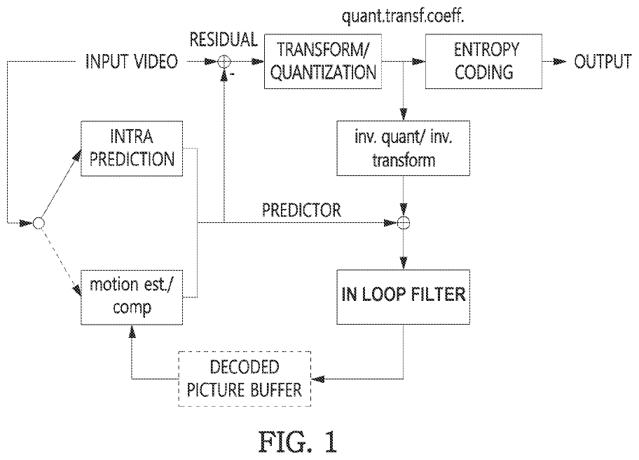

FIG. 1 is a diagram illustrating an example of a video coding method.

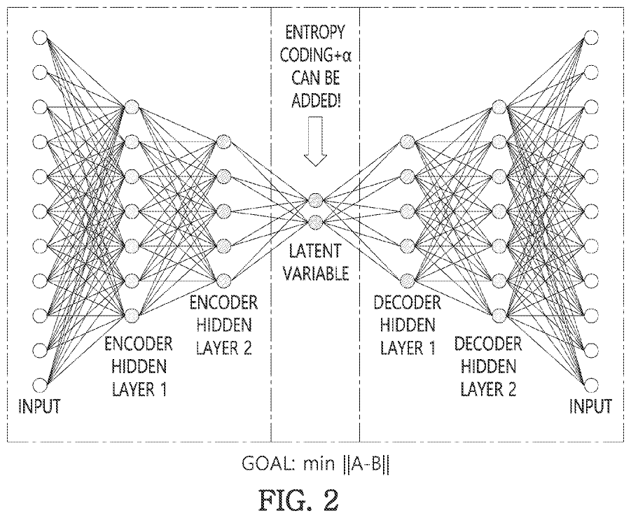

FIG. 2 is a diagram conceptually illustrating autoencoder-based compression technology, which is one of deep learning-based image compression technologies.

Conventional coding technology is a method for predicting a block in an image to subsequently appear or an image in a subsequent frame using previous information, compressing a difference image (residual) between a prediction image and an input image (video) using both an energy transform function, such as a discrete cosine transform (DCT), and entropy coding, and transmitting compressed information.

Consequently, this is technology related to a method for minimizing the difference between the input image and an output image.

Recent deep-learning-based image compression technology is a method for representing an existing encoding effect by extracting an abstracted hidden vector using a deep neural network instead of a prediction encoding and entropy encoding module required for video coding, and by transmitting the extracted hidden vector.

In order to improve image compression efficiency, the deep neural network is trained such that an encoded hidden vector may be represented by a smaller number of bits while the quality of a reconstructed image may be improved.

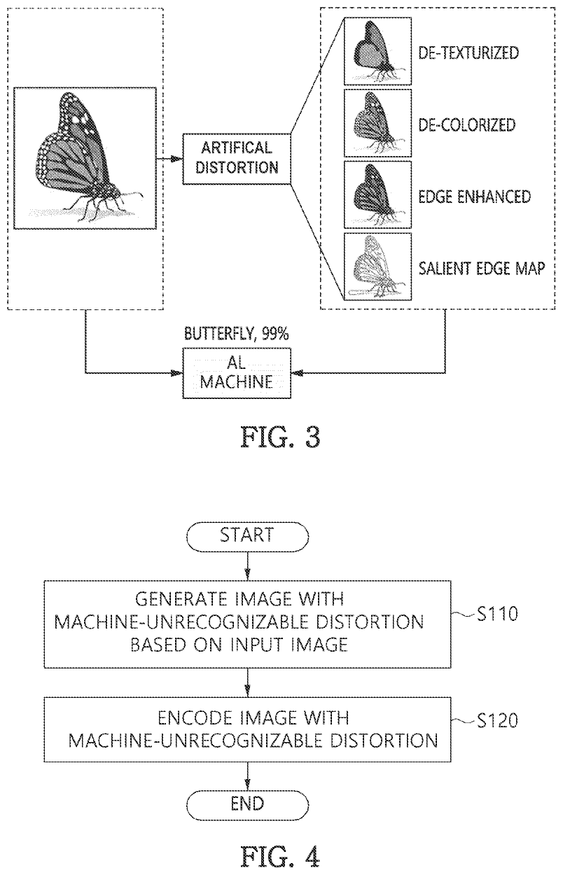

Hereinafter, machine-unrecognizable distortion used in the present invention will be described with reference to FIG. 3.

FIG. 3 is a diagram illustrating examples of the type of machine-unrecognizable distortion.

Generally, an artificial intelligence (AI)-based machine, which is configured using a deep learning network, is designed to be robust to various types of distortion for an original object. As illustrated in FIG. 3, although various modifications are applied to a butterfly, such as by simplifying texture (de-texturizing), removing colors (de-colorizing), or leaving only an edge (edge enhancement), the Al-based machine is trained to classify the object as a butterfly.

That is, the term “machine-unrecognizable distortion” means distortion formed to allow the machine to determine that a distorted object has the same meaning as the original object. Such machine-unrecognizable distortion may also mean distortion within a range in which the corresponding distortion is not recognized as distortion by the machine.

Such distortion is widely used as a method for artificially increasing a dataset so as to improve robustness to machine judgment.

Therefore, it can be seen that, when an image is transmitted to include machine-unrecognizable distortion, the same result may be obtained regardless of whether the actual machine vision task is performed.

Consequently, the present invention describes a method for, when video is encoded/decoded in an environment for machine vision application, encoding an image, which is generated by inserting machine-unrecognizable distortion, transmitting the encoded image, decoding the encoded image, and utilizing the decoded image as the input of machine vision.

FIG. 4 is a flowchart illustrating an image processing method for machine vision according to an embodiment of the present invention.

Referring to FIG. 4, the image processing method performed by an image processing apparatus for machine vision generates an image in which machine-unrecognizable distortion is applied to an input image (hereinafter referred to as a ‘image with machine-unrecognizable distortion’) at step S110.

Here, the input image may be an image acquired through a camera, a charge coupled device (CCD) sensor, or the like.

Here, the image with machine-unrecognizable distortion may be generated using at least one of a typical image processing method or a deep learning network or combination thereof.

Here, the deep learning network may correspond to an autoencoder using a convolutional neural network (CNN) or a generative adversarial network (GAN).

Here, in consideration of coding cost and performance error cost of machine vision as loss functions, network performance may be optimized.

Here, the deep learning network may be trained based on predetermined loss function candidates. Here, the loss function candidates may include at least one of a first loss function corresponding to a generation error between the input image and the image with machine-unrecognizable distortion, a second loss function corresponding to a difference in performance between the results obtained by individually performing a machine vision task on the input image and the image with machine-unrecognizable distortion, or a third loss function corresponding to the difference between coding bit amounts of the input image and the image with machine-unrecognizable distortion, or combination thereof.

Alternatively, a weighted average of at least two of the first loss function, the second loss function, or the third loss function may be included in the loss function candidates. The number of usable loss function candidates may be 1, 2, 3 or more, and the number or type of usable loss function candidates may be variously defined depending on the task of machine vision. Further, the number or type of usable loss function candidates may be variously defined depending on the number of image with machine-unrecognizable distortions, or the type or strength of distortion.

The deep learning network may perform learning by setting a weighted average of at least two of the first loss function, the second loss function, or the third loss function or combination thereof as the total loss function.

Because each of the first loss function, the second loss function, and the third loss function can be represented in a differentiable form, the loss functions may be optimized.

The image with machine-unrecognizable distortion may correspond to an image in which distortion corresponding to the characteristics of the machine vision task is added to the input image.

The distortion corresponding to the characteristics of the machine vision task may include de-texturization, edge detection, color channel extraction (de-colorization), frequency extraction using a band-pass filter, etc.

For example, when the machine vision task is object detection, there is a need to have robustness to details upon performing object detection. When a task for recognizing a person is performed, a small spot on the face of the person, a pattern on clothes, or the like does not influence the performance of the task.

Therefore, an image in which distortion for removing fine texture information is included in the input image may be transmitted. The texture is composed of color changes, and thus a large amount of information is required for encoding and transmitting the texture.

When the texture information is simplified (de-texturized) and transmitted in this way, data may be transmitted as a smaller amount of information.

Distortion corresponding to the characteristics of the machine vision task may vary with the role and configuration of the machine vision task, and is not limited to the above-described example.

The image with machine-unrecognizable distortion may be an image to which multiple distortion components are added. Various types of distortion, described above, may be added to one input image, or multiple image with machine-unrecognizable distortions may be generated by adding the same type of distortion with different strengths. Alternatively, multiple image with machine-unrecognizable distortions may be generated by individually adding various types of distortion to the same input image.

The processes of adding multiple distortion components may be performed in parallel or simultaneously.

Next, each image with machine-unrecognizable distortion is encoded at step S120.

Step S120 of encoding the image with machine-unrecognizable distortion may be performed using a video-coding scheme such as advanced video coding (AVC) (H.264), high efficiency video coding (HEVC) (H.265), or versatile video coding (VVC) (H.266).

Here, although not illustrated in FIG. 4, the image processing method according to an embodiment of the resent invention may further include the step of transmitting information about distortion added to the encoded image and to the image with machine-unrecognizable distortion, the step of encoding the encoded image, and the step of adjusting the strength of the distortion based on the information about the distortion and the characteristics of the machine vision task.

That is, a distortion corrected image may be reconstructed depending on the characteristics of the machine vision task, and the distorted image or the reconstructed image may be used as the input of machine vision.

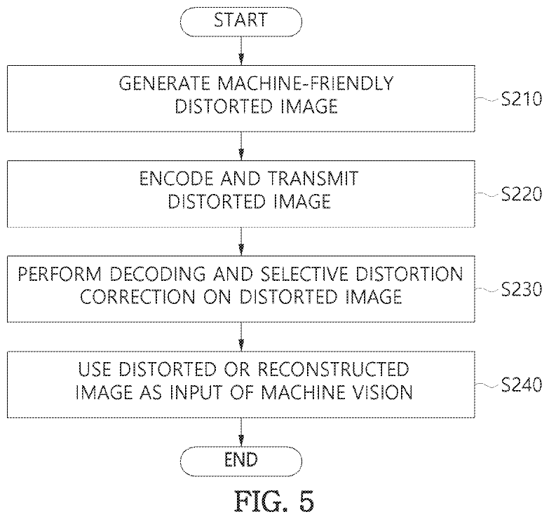

FIG. 5 is a flowchart illustrating an image processing method for machine vision according to another embodiment of the present invention.

Referring to FIG. 5, the image processing method according to another embodiment, which is performed by an image processing apparatus for machine vision, receives an image and generates a machine-friendly distorted image at step S210.

At step S210 of generating the machine-friendly distorted image, a distortion preprocessing module or a deep learning-based preprocessing model may be used when a distorted image is generated.

Here, an image including machine-friendly distortion may be generated in consideration of the characteristics of a machine vision task.

Here, at least one of prestored machine task information or distortion network information (Net ID) or combination thereof may be utilized.

For example, the machine task information and the distortion network information may be stored in the form of a table, and then an appropriate distortion network may be selected to utilize.

Here, the machine-friendly image may be an image having higher performance with the same amount of data, or an image having a smaller amount of data for the same performance.

That is, the machine-friendly image may be an image having excellent performance versus the amount of data when the machine vision performs a task.

Here, at the step of generating the machine-friendly distorted image, two or more types of distortion may be mixed and used. The machine-friendly distorted image may refer to the above-described image with machine-unrecognizable distortion or some of multiple image with machine-unrecognizable distortions (e.g., an image with machine-unrecognizable distortion to which a specific type of distortion is added). Alternatively, the machine-friendly distorted image may refer to an image generated by mixing two or more types of images, among the multiple image with machine-unrecognizable distortions, with each other. Alternatively, the machine-friendly distorted image may refer to an image in which distortion correction is additionally applied to the above-described image with machine-unrecognizable distortion.

Next, the distorted image may be encoded and transmitted at step S220.

That is, the image processing method according to the embodiment of the present invention may have higher transmission efficiency by encoding and transmitting the distorted image instead of the input image.

Here, when the receiver needs to reconstruct distortion, distortion information may be transmitted together with the distorted image, thus enabling the distortion information to be utilized.

Next, decoding and selective distortion correction may be performed on the distorted image at step S230.

That is, at step S230, the distorted image may be reconstructed by decoding the encoded image, and a distortion-free image may be reconstructed again from the distorted image depending on the characteristics of machine vision.

Subsequently, the distorted image or the reconstructed image may be used as the input of machine vision at step S240.

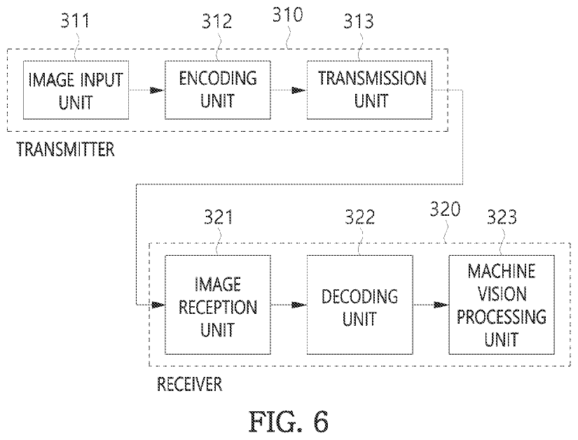

Hereinafter, an image processing system according to the present invention will be described in detail with reference to FIGS. 6 to 8.

FIG. 6 is a diagram illustrating a machine vision processing system using an encoder and a decoder.

Referring to FIG. 6, a transmitter 310 includes an image input unit 311, an encoding unit 312, and a transmission unit 313, and a receiver 320 includes an image reception unit 321, a decoding unit 322, and a machine vision processing unit 323.

When an image is input to the image input unit 311 composed of a camera and a charge coupled device (CCD) sensor, the encoding unit 312 compresses the input image into a small amount of data using a video encoding scheme such as AVC(H.264), HEVC(H.265), or VVC(H.266).

Here, a compressed video stream may be transmitted, along with information such as additional information or audio information, through the transmission unit 313.

The transmitted stream may be received by the image reception unit 321, after which a compressed video stream is separated from the received stream and is transmitted to the decoding unit 322.

The decoding unit 322 reconstructs the compressed video stream into an image close to the original image, and transfers the reconstructed image to the machine vision processing unit 323. The machine vision processing unit 323 performs a task such as a task of recognizing a person or an object based on the input image.

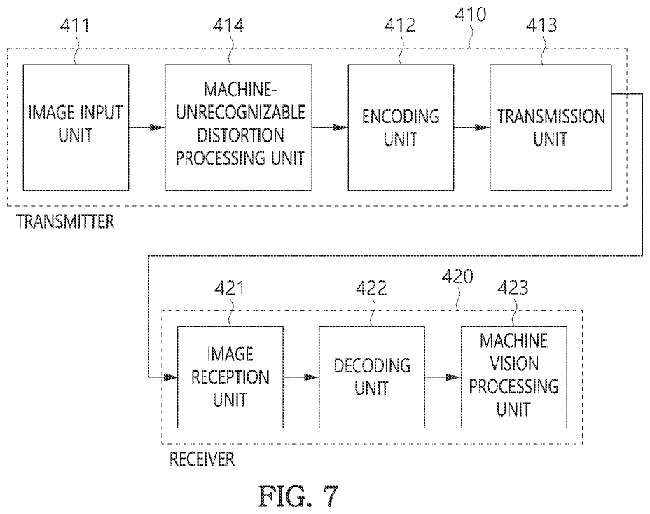

FIG. 7 is a block diagram illustrating a system for processing machine vision according to an embodiment of the present invention.

Referring to FIG. 7, a transmitter 410 includes an image input unit 411, an encoding unit 412, a transmission unit 413, and a machine-unrecognizable distortion processing unit 414 and a receiver 420 includes an image reception unit 421, a decoding unit 422, and a machine vision processing unit 423.

The embodiment of the present invention is characterized in that an input image (video) is received, an image including machine-friendly distortion (i.e., a machine-friendly distorted image) is generated, and the machine-friendly distorted image is encoded/decoded and transmitted, upon performing encoding/decoding on the input image.

The machine-unrecognizable distortion processing unit 414 generates an image with machine-unrecognizable distortion based on the input image, and transfers the same to the encoding unit 412, thus enabling an encoded image to be transmitted through the transmission unit 413.

The image reception unit 421 receives the encoded image, and the decoding unit 422 decodes the distorted image, and performs a machine vision task on the decoded image.

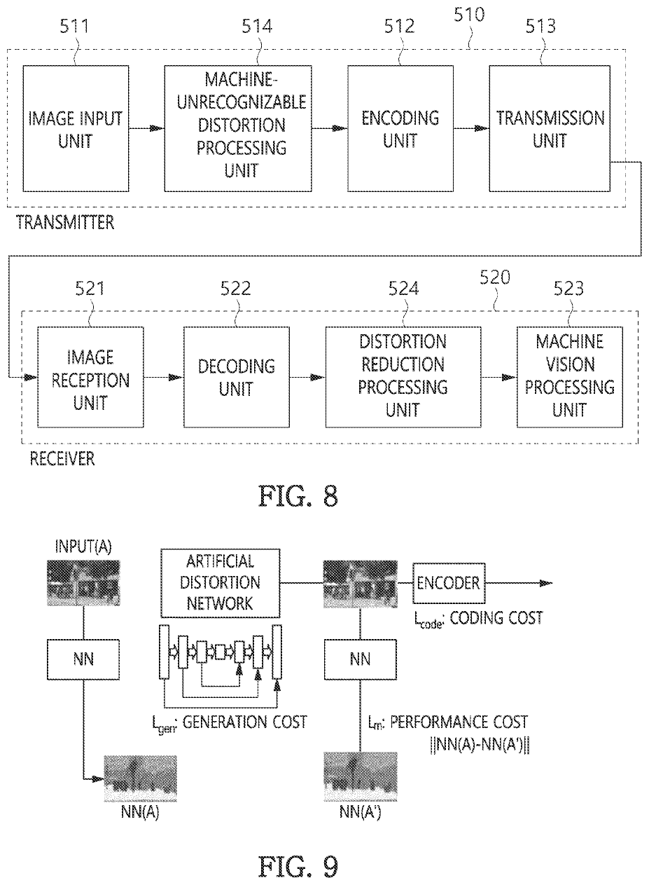

FIG. 8 is a block diagram illustrating a system for processing machine vision according to another embodiment of the present invention.

Referring to FIG. 8, a transmitter 510 includes an image input unit 511, an encoding unit 512, a transmission unit 513, and a machine-unrecognizable distortion processing unit 514, and a receiver 520 includes an image reception unit 521, a decoding unit 522, a machine vision processing unit 523, and a distortion reduction processing unit 524.

Referring to the receiver 520 of FIG. 8, it can be seen that, unlike the embodiment of FIG. 7, the distortion reduction processing unit 524 is additionally included.

Here, the distortion reduction processing unit 524 may further improve the performance of machine vision processing by performing a function of removing or reducing distortion added by the machine-unrecognizable distortion processing unit 514 of the transmitter 510.

Here, the method for generating machine-unrecognizable distortion may be performed using typical image processing or using a deep learning network.

For example, in the case of an object recognition task, texture may be reduced or only an edge may be extracted. Alternatively, a specific color or a color channel, which is considered by the machine vision task to be significant, may be extracted from a color image, and only a specific frequency component considered in machine vision may be extracted through a band-pass filter.

The selection of the distortion generation method may vary depending on the role and configuration of the machine vision processing unit of device configuration, and procedures related to this image processing may be performed simultaneously or in parallel with each other.

FIG. 9 is a diagram illustrating an example of a structure for training a network that generates machine-unrecognizable distortion.

Referring to FIG. 9, the machine-unrecognizable distortion generation network may be an autoencoder using a convolutional neural network (CNN), or a generative adversarial network (GAN), and may optimize network performance by considering together coding cost and performance error cost in machine vision.

Here, when an error between input and an image generated over the network is given as a generation error (i.e., generation cost L_{gen}) with respect to a dataset in which machine-unrecognizable distortion is included in input, the generation error (generation cost) may be represented by the difference between input image A and A′, generated over the network.

Here, when the result of performing the machine vision task on image A is given as NN(A), the difference between respective results of performing the machine vision task on the input image and the output image may be regarded as a performance error (i.e., performance cost Lₘ).

Finally, when the difference between the amounts of bits required for encoding input image A and that required for image A′ is given as encoding cost Lee, the total loss function may be represented by _{w1}L_{gen}+_{w2}L_{code}+_{w3}Lₘ, and the deep learning network may be trained to minimize the loss function.

Because each cost function may be represented in a differential form, optimization for the cost function may be realized.

Below, the present invention will be described based on an application related to recognition of an object and detection of a location by way of example. When an object is recognized, there is a need to occasionally ignore or to be robust to some details.

For instance, when a person is recognized, a small dot on the face of the person or a pattern on the clothes of the person does not greatly influence the recognition.

Therefore, distortion for removing such fine texture information from the corresponding object may be included in an image, and thus a resulting distorted image may be transmitted. Generally, texture is composed of changes in colors, and a larger amount of information is required as the representation of the texture is more precisely performed.

Therefore, when the texture information is simplified and transmitted, data may be transmitted as a smaller amount of information.

FIG. 10 is a diagram illustrating the result of performing object detection on an original input image.

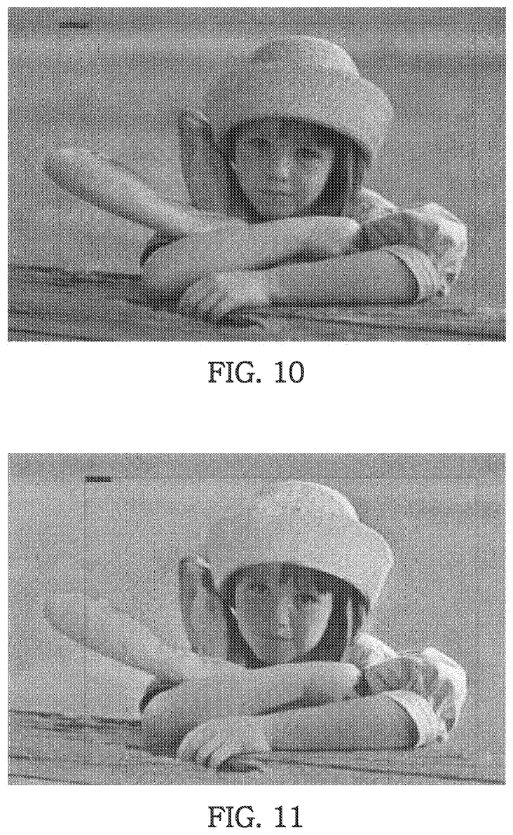

FIG. 11 is a diagram illustrating the result of performing object detection on a de-texturized image.

Referring to FIGS. 10 and 11, it can be proven that when using jpeg compression, the image of FIG. 11 shows that the distorted image has a recognition performance similar to that of an original image, and has an improved compression efficiency of about 20% or more.

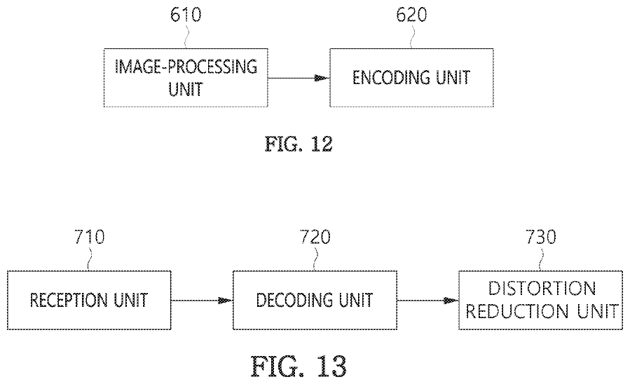

FIG. 12 is a block diagram illustrating an image processing apparatus (transmitter) according to an embodiment of the present invention.

Referring to FIG. 12, the image processing apparatus (encoding apparatus) for machine vision according to an embodiment of the present invention includes an image-processing unit 610 for generating an image with machine-unrecognizable distortion based on an input image and an encoding unit 620 for encoding the image with machine-unrecognizable distortion.

The image processing unit 610 may generate the image with machine-unrecognizable distortion using a deep learning network.

Here, the deep learning network may be trained based on predetermined loss function candidates. Here, the loss function candidates may include at least one of a first loss function corresponding to a generation error between the input image and the image with machine-unrecognizable distortion, a second loss function corresponding to a difference in performance between the results obtained by individually performing a machine vision task on the input image and the image with machine-unrecognizable distortion, or a third loss function corresponding to the difference between coding bit amounts of the input image and the image with machine-unrecognizable distortion, or combination thereof.

Alternatively, a weighted average of at least two of the first loss function, the second loss function, or the third loss function may be included in the loss function candidates. The number of usable loss function candidates may be 1, 2, 3 or more, and the number or type of usable loss function candidates may be variously defined depending on the task of machine vision. Further, the number or type of usable loss function candidates may be variously defined depending on the number of image with machine-unrecognizable distortions, or the type or strength of distortion.

Various types of distortion, described above, may be added to a single input image, and various types of distortion may be individually added to a single input image, and multiple image with machine-unrecognizable distortions may be generated.

Here, each image with machine-unrecognizable distortion may correspond to an image in which distortion corresponding to the characteristics of the machine vision task is added to the input image.

The distortion corresponding to the characteristics of the machine vision task may include de-texturization, edge detection (edge enhancement), and color channel extraction (de-colorization).

Here, the image with machine-unrecognizable distortion may be an image to which multiple distortion components are added. Various types of distortion, described above, may be added to one input image, or multiple image with machine-unrecognizable distortions may be generated by adding the same type of distortion with different strengths. Alternatively, multiple image with machine-unrecognizable distortions may be generated by individually adding various types of distortion to the same input image.

Although not illustrated in FIG. 12, the image processing apparatus for machine vision according to an embodiment may further include a transmission unit for transmitting information about distortion added to an encoded image and to the image with machine-unrecognizable distortion.

The information about distortion may include at least one of the type of task or sub-task, information indicating presence or non-presence of distortion, the number of available distortion components, the number or type of distortion components added to the input image, the strength of distortion, a coefficient for reducing distortion strength, or the number of encoded images with machine-unrecognizable distortion (e.g., including the maximum number or minimum number of images or combination thereof) or combination thereof. Any one of the pieces of information about distortion may be received selectively/dependently on another thereof. In addition to the information about distortion, information about distortion correction may be further transmitted. The information about distortion correction may include information indicating whether distortion correction is to be performed, the strength of distortion correction, a correction coefficient, etc. The information about distortion correction may be individually defined and transmitted depending on the machine vision tasks. Alternatively, some of multiple machine vision tasks may share information about the same distortion correction with each other. Alternatively, regardless of the types of machine vision tasks, information about the same predefined distortion correction may be used. Alternatively, the information about distortion correction may be encoded only for a specific task, among predefined machine vision tasks, and may not be encoded for other tasks.

FIG. 13 is a block diagram illustrating an image processing apparatus (receiver) according to an embodiment of the present invention.

Referring to FIG. 13, an image processing apparatus (decoding apparatus) according to an embodiment of the present invention includes a reception unit 710 for receiving an encoded image with machine-unrecognizable distortion, a decoding unit 720 for decoding the received image with machine-unrecognizable distortion, and a distortion reduction unit 730 for reducing the distortion strength of the decoded image with machine-unrecognizable distortion.

Here, the reception unit 710 may receive information about distortion added to the image with machine-unrecognizable distortion, along with the image with machine-unrecognizable distortion. The information about distortion has been described in detail with reference to FIG. 12. In addition, information about distortion correction may be additionally received, and detailed descriptions thereof will be omitted.

Here, distortion added to the image with machine-unrecognizable distortion may include de-texturization, edge detection (edge enhancement), and color channel extraction (de-colorization).

Here, the distortion reduction unit 730 may reduce the strength of distortion based on the information about distortion and the characteristics of each machine vision task.

The image with machine-unrecognizable distortion may be an image to which multiple distortion components are added.

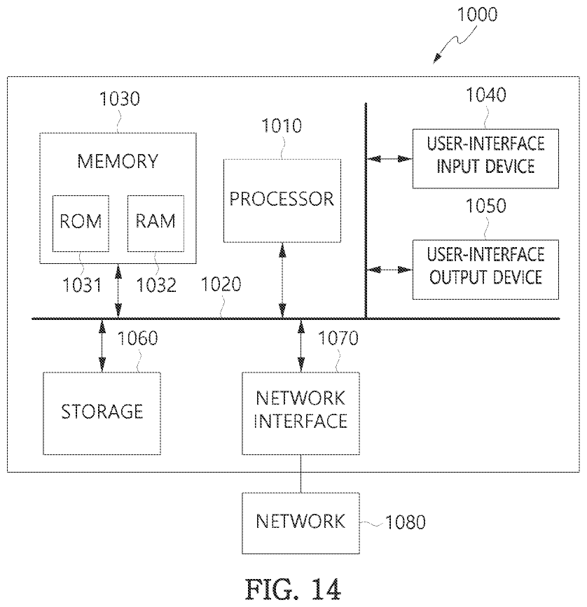

FIG. 14 is a diagram illustrating the configuration of a computer system according to an embodiment.

An image processing apparatus for machine vision according to an embodiment may be implemented in a computer system 1000, such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium, and an information delivery medium. For example, the memory 1030 may include Read-Only Memory (ROM) 1031 or Random Access Memory (RAM) 1032.

Specific executions described in the present invention are embodiments, and the scope of the present invention is not limited to specific methods. For simplicity of the specification, descriptions of conventional electronic components, control systems, software, and other functional aspects of the systems may be omitted. As examples of connections of lines or connecting elements between the components illustrated in the drawings, functional connections and/or circuit connections are exemplified, and in actual devices, those connections may be replaced with other connections, or may be represented by additional functional connections, physical connections or circuit connections. Furthermore, unless definitely defined using the term “essential”, “significantly” or the like, the corresponding component may not be an essential component required in order to apply the present invention.

In accordance with the present invention, an image (or a video) having high compressibility while maintaining the performance of machine vision tasks may be generated in consideration of the characteristics of the machine vision tasks.

Further, the present invention may provide an image processing method that is capable of adjusting the extent of distortion depending on the characteristics of machine vision tasks or as occasion demands.

Therefore, the spirit of the present invention should not be limitedly defined by the above-described embodiments, and it is appreciated that all ranges of the accompanying claims and equivalents thereof belong to the scope of the spirit of the present invention.

What is claimed is:

1. An image processing method for machine vision, comprising:
generating an image with machine-unrecognizable distortion based on an input image; and
encoding the image with machine-unrecognizable distortion.

2. The image processing method of claim 1, wherein generating the image with machine-unrecognizable distortion comprises:
generating the image with machine-unrecognizable distortion using a deep learning network.

3. The image processing method of claim 2, wherein the deep learning network is trained based on:
a first loss function corresponding to a generation error between the input image and the image with machine-unrecognizable distortion,
a second loss function corresponding to a difference in performance between results obtained by individually performing a machine vision task on the input image and the image with machine-unrecognizable distortion, and
a third loss function corresponding to a difference between coding bit amounts of the input image and the image with machine-unrecognizable distortion.

4. The image processing method of claim 1, wherein the image with machine-unrecognizable distortion is generated by adding distortion corresponding to a characteristic of a machine vision task to the input image.

5. The image processing method of claim 4, wherein the distortion corresponding to the characteristic of the machine vision task includes de-texturization, edge detection, or de-colorization.

6. The image processing method of claim 5, wherein the image with machine-unrecognizable distortion is an image to which multiple distortion components are added.

7. The image processing method of claim 1, further comprising:
transmitting information about distortion added to an encoded image and the image with machine-unrecognizable distortion.

8. The image processing method of claim 7, further comprising:
decoding the encoded image; and
reducing strength of the distortion based on the information about the distortion and a characteristic of a machine vision task.

9. An image processing apparatus for machine vision, comprising:
an image-processing unit for generating an image with machine-unrecognizable distortion based on an input image; and
an encoding unit for encoding the image with machine-unrecognizable distortion.

10. The image processing apparatus of claim 9, wherein the image-processing unit generates the image with machine-unrecognizable distortion using a deep learning network.

11. The image processing apparatus of claim 10, wherein the deep learning network is trained based on:
a first loss function corresponding to a generation error between the input image and the image with machine-unrecognizable distortion,
a second loss function corresponding to a difference in performance between results obtained by individually performing a machine vision task on the input image and the image with machine-unrecognizable distortion, and
a third loss function corresponding to a difference between coding bit amounts of the input image and the image with machine-unrecognizable distortion.

12. The image processing apparatus of claim 9, wherein the image with machine-unrecognizable distortion is generated by adding distortion corresponding to a characteristic of the machine vision task to the input image.

13. The image processing apparatus of claim 12, wherein the distortion corresponding to the characteristic of the machine vision task includes de-texturization, edge detection, or de-colorization.

14. The image processing apparatus of claim 13, wherein the image with machine-unrecognizable distortion is an image to which multiple distortion components are added.

15. The image processing apparatus of claim 12, further comprising:
a transmission unit for transmitting information about distortion added to an encoded image and the image with machine-unrecognizable distortion.

16. An image processing apparatus for machine vision, comprising:
a reception unit for receiving an encoded image with machine-unrecognizable distortion;
a decoding unit for decoding the received image with machine-unrecognizable distortion; and
a distortion reduction unit for reducing strength of distortion of the decoded image with machine-unrecognizable distortion.

17. The image processing apparatus of claim 16, wherein the reception unit receives information about distortion added to the image with machine-unrecognizable distortion, along with the image with machine-unrecognizable distortion.

18. The image processing apparatus of claim 17, wherein the distortion added to the image with machine-unrecognizable distortion includes de-texturization, edge detection, or de-colorization.

19. The image processing apparatus of claim 18, wherein the distortion reduction unit reduces the strength of the distortion based on the information about the distortion and a characteristic of a machine vision task.

20. The image processing apparatus of claim 18, wherein the image with machine-unrecognizable distortion is an image to which multiple distortion components are added.
